(19) United States
(12) Patent Application Publication
(10) Pub. No.: US 2007/0235081 A1
(43) Pub. Date: Oct. 11, 2007

(54) Anion-liquid-saving apparatus

(76) Inventor: Chi-Chang Wang, Taipei Hsien (TW)

Correspondence Address: CHI-CHANG WANG, 235 Chung - Ho, Box 8-24, Taipei, TW

(21) Appl. No.: 11/385,601

(22) Filed: Mar. 22, 2006

(51) Int. Cl. B67D 5/54

(52) U.S. Cl. 137/207

(57) ABSTRACT

A anion-liquid-saving apparatus comprises a body having a penetrating channel and an assembly tube extended from the penetrating channel; an inner side of the assembly tube having an inner threaded channel which is communicated to the penetrating channel; at least one water-stop washer and a negative pressure adjusting check valve being installed in the assembly tube. The negative pressure adjusting check valve has a penetrating conduit; the penetrating conduit is communicated to and vertical to the penetrating channel. One end of the negative pressure adjusting check valve is installed with a stud; an outer side of the stud is installed with a sectional thread; and another end of the negative pressure adjusting check valve is installed with a guide post; an outer side of the guide post has thread for screwing other element. The liquid is one of water and oil.

### FIELD OF THE INVENTION

The present invention relates to anion liquid, and particularly to anion-liquid-saving apparatus, wherein by the number of water-stop washers and adjusting of the negative pressure of a negative pressure adjusting check valve, the flow of the anion liquid (water or oil) is adjustable and the value of the negative pressure is adjustable. The present invention has a simple structure, can be operated easily and liquid required is saved. Moreover, oxygen-contained anion liquid can be outputted.

### BACKGROUND OF THE INVENTION

The prior art apparatus for anion liquid has a complicated structure and the operation thereof is inconvenient. Thereby it is necessary to be improved.

### SUMMARY OF THE INVENTION

Accordingly, the primary object of the present invention is to provide a anion-liquid-saving apparatus, wherein by the number of water-stop washers and adjusting of the negative pressure of a negative pressure adjusting check valve, the flow of the anion liquid (water or oil) is adjustable and the value of the negative pressure is adjustable. The present invention has a simple structure, can be operated easily and liquid required is saved. Moreover, oxygen-contained anion liquid can be outputted.

To achieve above objects, the present invention provides a anion-liquid-saving apparatus which comprises: a body having a penetrating channel and an assembly tube extended from the penetrating channel; an inner side of the assembly tube having an inner threaded channel which is communicated to the penetrating channel; at least one water-stop washer and a negative pressure adjusting check valve being installed in the assembly tube. The negative pressure adjusting check valve has a penetrating conduit; the penetrating conduit is communicated to and vertical to the penetrating channel. One end of the negative pressure adjusting check valve is installed with a stud; an outer side of the stud is installed with a sectional thread; and another end of the negative pressure adjusting check valve is installed with a guide post; an outer side of the guide post has thread for screwing other element. The liquid is one of water and oil. The assembly tube can be installed with an air filter or a container with cleaning agent therein.

The various objects and advantages of the present invention will be more readily understood from the following detailed description when read in conjunction with the appended drawing.

### BRIEF DESCRIPTION OF THE DRAWINGS

FIG. 1 is an assembled schematic view about the embodiment of the present invention.

FIG. 2 shows one embodiment of the present invention.

FIG. 3 is a cross sectional view about the embodiment of the present invention.

FIG. 4 is a cross sectional view about another embodiment of the present invention.

FIG. 5 shows the use of the present invention.

FIG. 6 shows another use of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

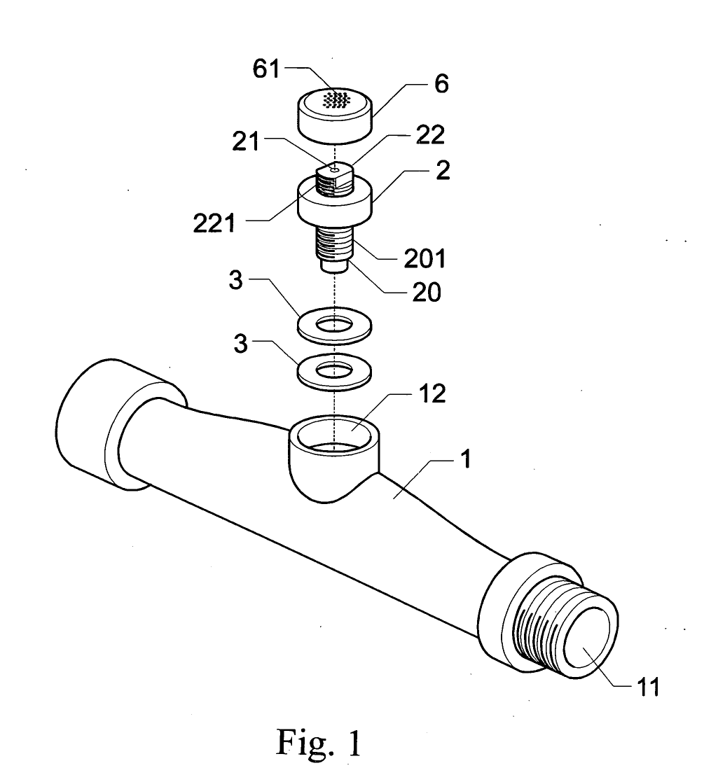

Referring to FIG. 1, the anion-liquid-saving apparatus of the present invention is illustrated. The present invention has the following elements.

A body 1 has a penetrating channel 11 and an assembly tube 12 extended from the penetrating channel 11. An inner side of the assembly tube 12 has an inner threaded channel 120 which is communicated to the penetrating channel 11. At least one water-stop washer 3 and a negative pressure adjusting check valve 2 is installed in the assembly tube 12. The negative pressure adjusting check valve 2 has a penetrating conduit 21. The penetrating conduit 21 is communicated to the penetrating channel 11. One end of the negative pressure adjusting check valve 2 is installed with a stud 20. An outer side of the stud 20 is installed with a sectional thread 201. Thereby the negative pressure adjusting check valve 2 can be screwedly installed to the inner threaded channel 120. Another end of the negative pressure adjusting check valve 2 is installed with a guide post 22. An outer side of the guide post 22 has a thread 221 for screwing other element.

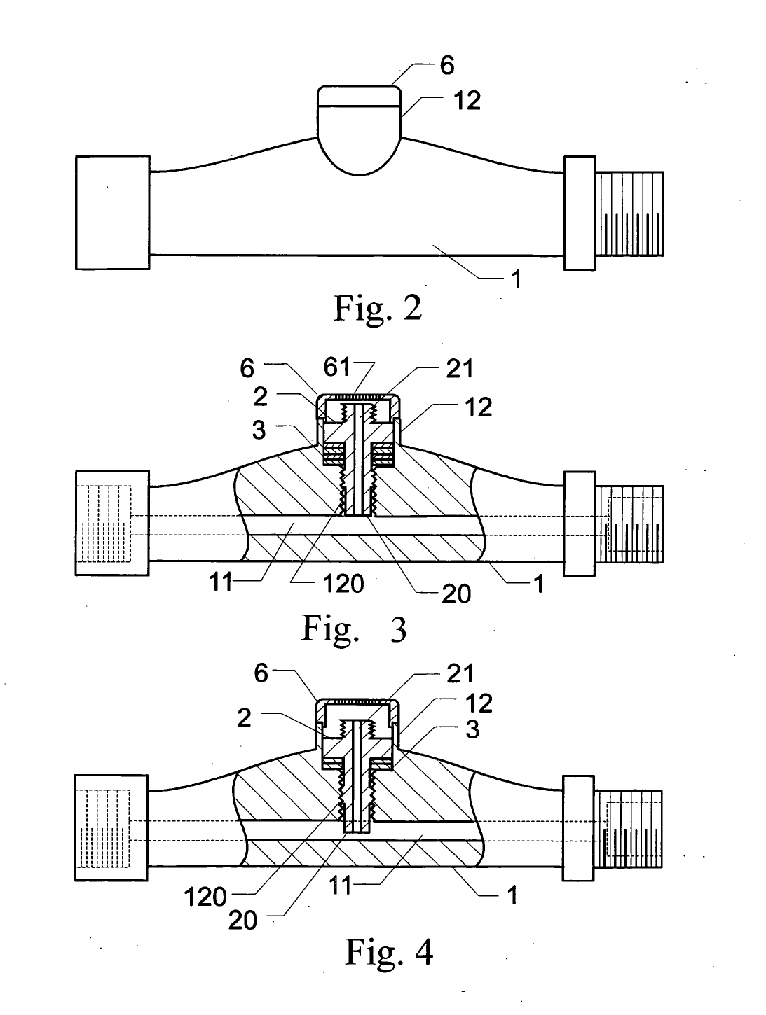

Referring to FIGS. 2 to 4, in the present invention, there may be several water-stop washers 3, which is determined by the amount of water flow. Thereby by adjusting the negative pressure adjusting check valve 2, the output flow of the anion liquid is adjustable.

Referring to FIG. 1, a cover 6 covers upon the assembly tube 12. The cover 6 has a vent 61 for venting air.

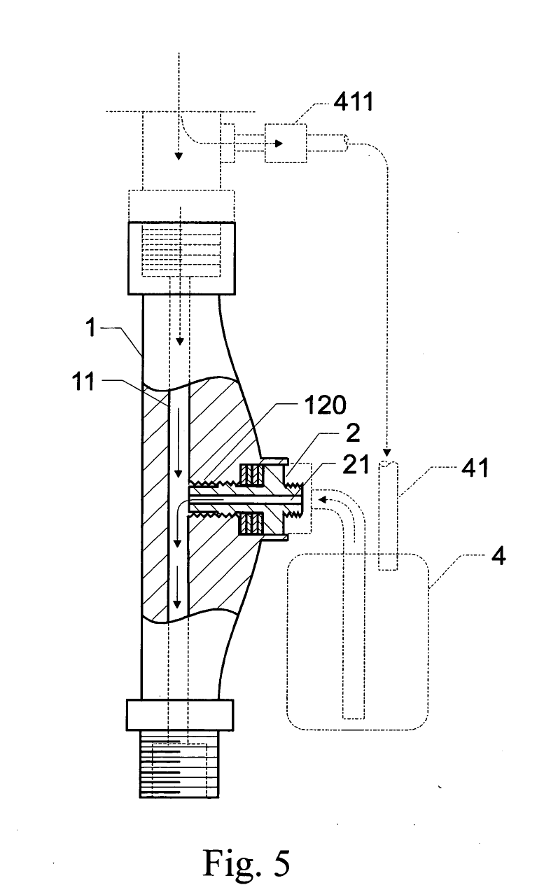

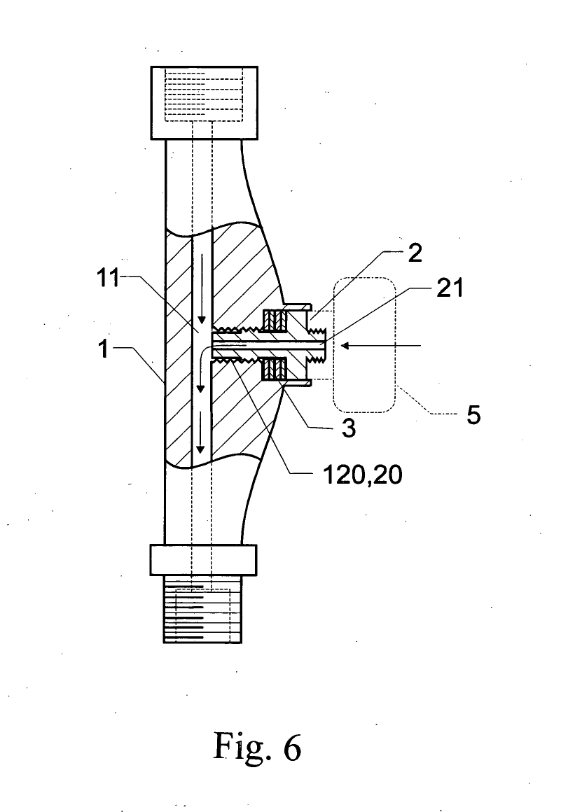

Referring to FIGS. 5 and 6, the operation of the present invention is illustrated. The use of the present invention is not confined to the embodiment illustrated in the drawing. When the present invention is used to other object (oil, water or fluid), all these are within the scope of the present invention.

Two applications of the present invention are illustrated. In one application, a cleaning device is added to the present invention as a flushing water saving device. In another application, an air filter is added to the present invention as a saving apparatus for getting oxygen-contained anion liquid. The applications will be described herein.

Referring to FIG. 5, a distal end of the negative pressure adjusting check valve 2 installed to the assembly tube 12 extending from the body 1 is connected to a container 4. A cleaning agent (such as solid cleaning agent, for example, a soap) is placed within the container 4. An injection tube 41 is connected between the container 4 and the liquid (water or oil) inlet of the body 1. A flow control valve 411 is installed on the injection tube 41. Liquid (water or oil) is guided into the container 4 through the injection tube 41 so as to form as cleaning liquid. The cleaning liquid is guided into the penetrating channel 11 by the negative pressure of the body 1. Thereby the cleaning liquid will mix with the liquid in the penetrating channel 11 to form a water saving flushing device with cleaning device.

Referring to FIG. 6, the distal end of the negative pressure adjusting check valve 2 is connected to an air filter 5. Air in the air filter 5 can be sucked into the penetrating channel 11 through the penetrating conduit 21 of the negative pressure adjusting check valve 2 by the negative pressure of the penetrating channel 11. Thereby the present invention is used as a anion-liquid-saving apparatus with oxygen. In this embodiment, the negative pressure adjusting check valve 2 of the assembly tube 12 can be assembled to the air filter 5.

Advantages of the present invention will be described herein. By the number of water-stop washers and adjusting of the negative pressure of a negative pressure adjusting check valve, the flow of the anion liquid (water or oil) is adjustable and the value of the negative pressure is adjustable. The present invention has a simple structure, can be operated easily and less liquid is required. Moreover, oxygen-contained anion liquid can be outputted.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A anion-liquid-saving apparatus comprising: a body having a penetrating channel and an assembly tube extended from the penetrating channel; an inner side of the assembly tube having an inner threaded channel which is communicated to the penetrating channel; at least one water-stop washer and a negative pressure adjusting check valve being installed in the assembly tube.

2. The anion-liquid-saving apparatus as claimed in claim 1, wherein the negative pressure adjusting check valve has a penetrating conduit; the penetrating conduit is communicated to and vertical to the penetrating channel.

3. The anion-liquid-saving apparatus as claimed in claim 1, wherein one end of the negative pressure adjusting check valve is installed with a stud; an outer side of the stud is installed with a sectional thread; thereby the negative pressure adjusting check valve is screwedly installed to the inner threaded channel; another end of the negative pressure adjusting check valve is installed with a guide post; an outer side of the guide post has thread for screwing other element.

4. The anion-liquid-saving apparatus as claimed in claim 1, wherein a plurality of water-stop washers is installed.

5. The anion-liquid-saving apparatus as claimed in claim 1, wherein the liquid is one of water and oil.

6. A saving cleaning apparatus for anion liquid comprising: a body having a penetrating channel and an assembly tube extended from the penetrating channel; an inner side of the assembly tube having an inner threaded channel which is communicated to the penetrating channel; at least one water-stop washer and a negative pressure adjusting check valve being installed in the assembly tube; and
a container installed at one end of the negative pressure adjusting check valve; and a cleaning agent being placed within the container; an injection tube being connected between the container and the assembly tube of the body.

7. The anion-liquid-saving apparatus as claimed in claim 6, wherein the negative pressure adjusting check valve has a penetrating conduit; the penetrating conduit is communicated to and vertical to the penetrating channel.

8. The anion-liquid-saving apparatus as claimed in claim 7, wherein one end of the negative pressure adjusting check valve is installed with a stud; an outer side of the stud is installed with a sectional thread; thereby the negative pressure adjusting check valve is screwedly installed to the inner threaded channel; another end of the negative pressure adjusting check valve is installed with a guide post; and an outer side of the guide post has thread for screwing other element.

9. The anion-liquid-saving apparatus as claimed in claim 6, wherein a plurality of water-stop washers is installed.

10. The anion-liquid-saving apparatus as claimed in claim 6, wherein a flow control valve is installed on the injection tube; liquid is guided into the container through the injection tube so as to form as cleaning liquid; and the cleaning liquid is guided into the penetrating channel by the negative pressure of the body.

11. The anion-liquid-saving apparatus as claimed in claim 6, wherein the liquid is one of water and oil.

12. A saving cleaning apparatus for anion liquid comprising: a body having a penetrating channel and an assembly tube extended from the penetrating channel; an inner side of the assembly tube having an inner threaded channel which is communicated to the penetrating channel; at least one water-stop washer and a negative pressure adjusting check valve being installed in the assembly tube; and
an air filter installed at one end of the negative pressure adjusting check valve.

13. The anion-liquid-saving apparatus as claimed in claim 12, wherein the negative pressure adjusting check valve has a penetrating conduit; the penetrating conduit is communicated to and vertical to the penetrating channel.

14. The anion-liquid-saving apparatus as claimed in claim 12, wherein one end of the negative pressure adjusting check valve is installed with a stud; an outer side of the stud is installed with a sectional thread; thereby the negative pressure adjusting check valve is screwedly installed to the inner threaded channel; another end of the negative pressure adjusting check valve is installed with a guide post; an outer side of the guide post has thread for screwing other element.

15. The anion-liquid-saving apparatus as claimed in claim 12, wherein a plurality of water-stop washers is installed.

16. The anion-liquid-saving apparatus as claimed in claim 12, wherein the liquid is one of water and oil.
